(19) United States
(12) Patent Application Publication
(10) Pub. No.: US 2025/0093585 A1
(43) Pub. Date: Mar. 20, 2025

(54) OPTICAL STRUCTURE CAPABLE OF INCREASING RETURN LOSS AND MANUFACTURING METHOD THEREOF

(71) Applicant: BLOVELIGHT (GUANGDONG) INTELLIGENT TECHNOLOGY CO., LTD., Dongguan (CN)

(72) Inventors: Wei ZHAO, Sichuan (CN); Dawei GUO, Hubei (CN)

(21) Appl. No.: 18/495,553

(22) Filed: Oct. 26, 2023

(30) Foreign Application Priority Data
Sep. 15, 2023 (CN) 2023111948469

(51) Int. Cl. G02B 6/30; G02B 6/32

(52) U.S. Cl. CPC G02B 6/30; G02B 6/322; G02B 6/325

(57) ABSTRACT

The present disclosure provides an optical structure capable of increasing return loss and a manufacturing method thereof. The optical structure includes: a light transmission body and a plurality of juxtaposed optical fibers, where, a plurality of juxtaposed insertion holes are disposed on the light transmission body; the plurality of optical fibers are inserted into the insertion holes one to one; an inclined end surface inclined at a preset angle relative to a vertical surface is formed at a front end of the optical fibers; a reflection surface aligned with the inclined end surfaces is disposed inside the light transmission body; an avoiding opening for accommodating an optical communication chip is disposed at a front bottom of the light transmission body; a plurality of focusing lenses in one-to-one correspondence with the optical fibers are disposed on a top wall of the avoiding opening.

### CROSS-REFERENCE TO RELATED APPLICATION

This application claims priority from the Chinese patent application 2023111948469 filed Sep. 15, 2023, the content of which is incorporated herein in the entirety by reference.

### TECHNICAL FIELD

The present disclosure relates to optical communication appliances, and in particular to an optical structure capable of increasing return loss and a manufacturing method thereof.

### BACKGROUND

Nowadays, common fiber arrays (FA) on the market have the structures as shown in FIGS. 1 and 2. In such structures, it is required to tightly press a plurality of optical fibers by using two sheets of processed glass, and then fixed by dispensing glue, and then an inclined surface is ground to form an optical surface, so as to achieve total reflection effect; then, it is coupled to a printed circuit board assembly (PCBA) board. However such structures have the following main defects:
1. The return loss of such optical modules is small, leading to a high error rate, module packet loss, failure of data transmission, and the like.
2. The requirement of the structures for coating reflectance of the chip surfaces is high. However, the reflectance of the chip surfaces cannot be directly measured, which is unfavorable for production management and control. In order to ensure the reflectance of the chips is within an ideal range, there is no choice but to select expensive high-precision chips.
3. The light spot of the structures is large, leading to an extremely tiny coupling tolerance, and hence high process requirements and low production yield.
4. During the manufacturing process of the existing structures, it is required to tightly press a plurality of fibers by using two sheets of processed glass, and then fix by dispensing glue and then ground, requiring a complex process and high costs.

### SUMMARY

In order to address the shortcomings of the prior arts, the present disclosure provides an optical structure capable of increasing return loss as well as improving return loss of optical signals, reducing error rate, has a simple structure, is easy to manufacture, and has less cost, and a manufacturing method thereof.

In order to address the above technical problems, the present disclosure adopts the following technical solution.

There is provided an optical structure capable of increasing return loss, which includes: a light transmission body and a plurality of juxtaposed optical fibers, where, a plurality of juxtaposed insertion holes are disposed on the light transmission body; the plurality of optical fibers are inserted into the insertion holes one to one; an inclined end surface inclined at a preset angle relative to a vertical surface is formed at a front end of the optical fibers; a reflection surface aligned with the inclined end surfaces is disposed inside the light transmission body; an avoiding opening for accommodating an optical communication chip is disposed at a front bottom of the light transmission body; a plurality of focusing lenses in one-to-one correspondence with the optical fibers are disposed on a top wall of the avoiding opening; the focusing lenses are located below the reflection surface; an optical signal emitted from the front end of the optical fibers is firstly reflected by the reflection surface and then passed through the focusing lenses into the optical communication chip.

Preferably, an included angle between the inclined end surfaces (20) and the vertical surface is 6° to 10°.

Preferably, an included angle between a light beam reflected by the reflection surface and the vertical surface is 6° to 20°.

Preferably, the focusing lenses are non-spherical focusing lenses.

Preferably, a glue dispensing opening is disposed at a rear end of the light transmission body, a plurality of optical fibers run through the glue dispensing opening, and a fixing glue is filled in the glue dispensing opening.

Preferably, the light transmission body is a plastic body.

There is provided a method of manufacturing the above optical structure, which includes the following steps: at step S1, prefabricating a light transmission body and preparing a plurality of optical fibers, where a plurality of juxtaposed insertion holes are disposed on the light transmission body; a reflection surface is disposed in the light transmission body; an avoiding opening is disposed at a front bottom of the light transmission body; a plurality of focusing lenses are disposed on a top wall of the avoiding opening; and an inclined end surface is disposed at a front end of the optical fibers; at step S2, inserting the plurality of optical fibers into the insertion holes one to one, where the inclined end surfaces are inclined at a preset angle relative to a vertical surface, and the inclined end surfaces are aligned with the reflection surface; at step S3, covering the avoiding opening above an optical communication chip; at step S4, when an optical signal is emitted from a front end of the optical fibers, reflecting the optical signal by the reflection surface and then transmitting the optical signal through the focusing lenses to the optical communication chip.

Preferably, a glue dispensing opening is disposed at a rear end of the light transmission body, and the method further includes a glue dispensing step: filling a fixing glue in the glue dispensing opening such that a plurality of optical fibers are fixed by the fixing glue in the glue dispensing opening.

Preferably, in the step S2, an included angle between the inclined end surfaces and the vertical surface is 6° to 10°.

Preferably, in the step S1, the light transmission body is formed by processing a plastic material, and the focusing lenses are non-spherical focusing lenses.

In the manufacturing process of the optical structure capable of increasing return loss in the present disclosure, a light transmission body is firstly prefabricated, and a plurality of optical fibers are prepared; a plurality of juxtaposed insertion holes are disposed on the light transmission body; a reflection surface is disposed in the light transmission body; an avoiding opening is disposed at a front bottom of the light transmission body; a plurality of focusing lenses are disposed on a top wall of the avoiding opening; further, the front ends of all optical fibers are to be provided with an inclined end surface; in a specific assembling process, the plurality of optical fibers are inserted into the insertion holes one to one while the inclined end surfaces are inclined at a preset angle relative to a vertical surface; the inclined end surfaces are aligned with the reflection surface; by fixing the plurality of optical fibers, one complete optical communication module is formed; finally, the avoiding opening is covered above an optical communication chip. When communication is performed with optical signals, an optical signal emitted from the front end of the optical fibers is reflected by the reflection surface and then run through the focusing lenses into the optical communication chip. Specifically, an optical signal emitted from the optical fibers is focused by the focusing lenses and then transmitted obliquely at an angle to the optical communication chip, so as to achieve the purpose of optimizing return loss and reducing the error rate. Further, the present disclosure has the advantages of simple structure, ease of manufacturing, and lower application costs.

### BRIEF DESCRIPTIONS OF THE DRAWINGS

FIG. 1 is a stereoscopic schematic diagram of a structure of an existing optical array (FA).

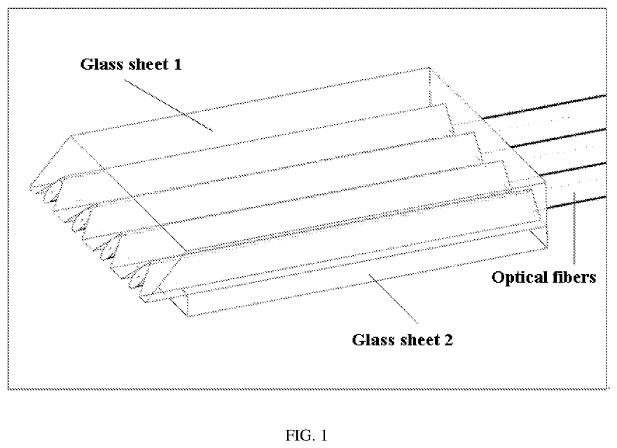

FIG. 2 is a sectional view of a structure of an existing optical array (FA).

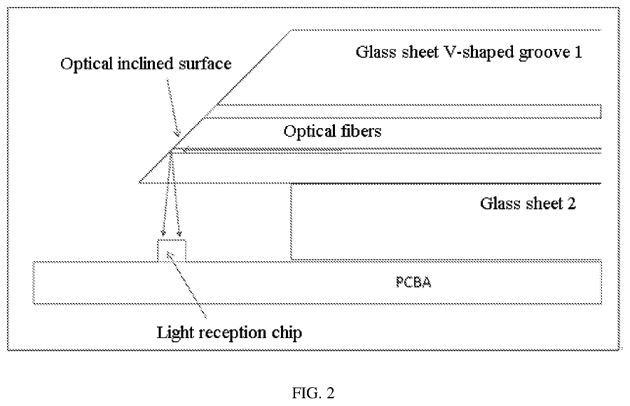

FIG. 3 is a sectional view of a structure of an optical structure of the present disclosure.

FIG. 4 is a stereoscopic view of an optical structure according to an embodiment of the present disclosure.

FIG. 5 is a stereoscopic view of an optical structure according to another embodiment of the present disclosure.

### DETAILED DESCRIPTIONS OF EMBODIMENTS

The present disclosure will be further detailed below in combination with drawings and specific embodiments.

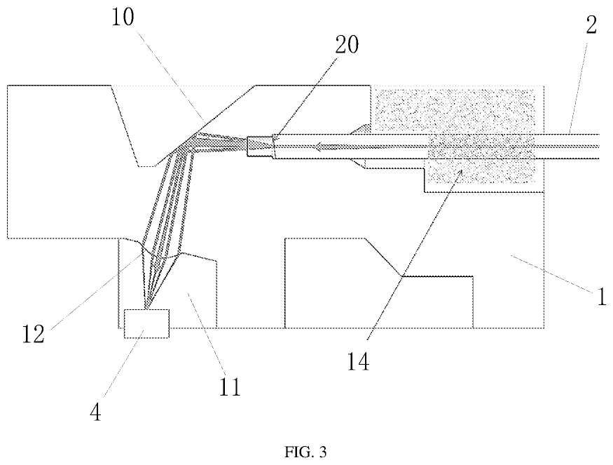

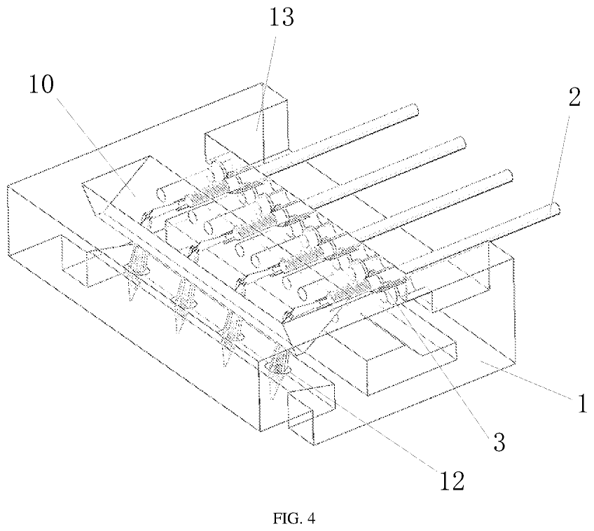

The present disclosure provides an optical structure capable of increasing return loss. As shown in FIGS. 3 and 4, the optical structure includes a light transmission body 1 and a plurality of juxtaposed optical fibers 2. A plurality of juxtaposed insertion holes 3 are disposed on the light transmission body 1, and the plurality of optical fibers 2 are inserted into the insertion holes 3 one to one. An inclined end surface 20 inclined at a preset angle relative to a vertical surface is formed at a front end of the optical fibers 2. A reflection surface 10 aligned with the inclined end surfaces 20 is disposed inside the light transmission body 1. An avoiding opening 11 for accommodating an optical communication chip 4 is disposed at a front bottom of the light transmission body 1. A plurality of focusing lenses 12 in one-to-one correspondence with the optical fibers 2 are disposed on a top wall of the avoiding opening 11. The focusing lenses 12 are located below the reflection surface 10, and an optical signal emitted from the front end of the optical fibers 2 is firstly reflected by the reflection surface 10 and then passed through the focusing lenses 12 into the optical communication chip 4.

In the manufacturing process of the above optical structure, a light transmission body 1 is firstly prefabricated, and a plurality of optical fibers 2 are prepared; a plurality of juxtaposed insertion holes 3 are disposed on the light transmission body 1; a reflection surface 10 is disposed in the light transmission body 1; an avoiding opening 11 is disposed at a front bottom of the light transmission body 1; a plurality of focusing lenses 12 are disposed on a top wall of the avoiding opening 11; further, the front ends of all optical fibers 2 are to be provided with an inclined end surface 20; in a specific assembling process, the plurality of optical fibers 2 are inserted into the insertion holes 3 one to one while the inclined end surfaces 20 are inclined at a preset angle relative to a vertical surface; the inclined end surfaces 20 are aligned with the reflection surface 10; by fixing the plurality of optical fibers 2, one complete optical communication module is formed; finally, the avoiding opening 11 is covered above an optical communication chip 4. When communication is performed with optical signals, an optical signal emitted from the front end of the optical fibers 2 is reflected by the reflection surface 10 and then run through the focusing lenses 12 into the optical communication chip 4. Specifically, an optical signal emitted from the optical fibers 2 is focused by the focusing lenses 12 and then transmitted obliquely at an angle to the optical communication chip 4, so as to achieve the purpose of optimizing return loss and reducing the error rate. Further, the present disclosure has the advantages of simple structure, ease of manufacturing, and lower application costs.

For the preferred angle of the inclined end surfaces 20, in this embodiment, an included angle between the inclined end surfaces 20 and the vertical surface is 6° to 10°. In an actual processing procedure, the end surface of the fibers is cut by laser cutting to form an angle of 6° to 10°.

In this embodiment, an included angle between a light beam reflected by the reflection surface 10 and the vertical surface is 6° to 20° such that the reflected light beam is obliquely transmitted to the optical communication chip 4.

As a preferred embodiment, the focusing lenses 12 are non-spherical focusing lenses.

In order to fix a plurality of optical fibers 2 fully, in this embodiment, a glue dispensing opening 13 is disposed at a rear end of the light transmission body 1. The plurality of optical fibers 2 all run through the glue dispensing opening 13, and a fixing glue 14 is filled in the glue dispensing opening 13. Compared with the manner in which the optical fibers are fixedly clamped by using two glass sheets in the prior arts, the manner of fixedly bonding a plurality of optical fibers 2 to the light transmission body 1 by dispensing the fixing glue 14 is more reliable.

In order to help manufacturing and formation and save costs, the light transmission body 1 is made of a plastic material. Specifically, the body made of a plastic material may be made of a plastic material with high light transmittance.

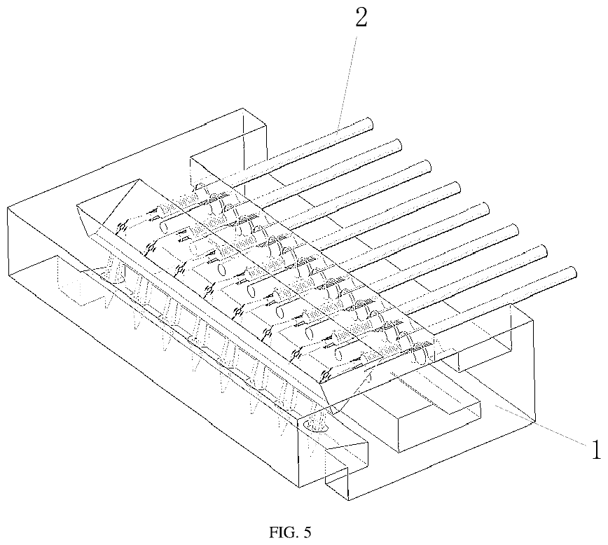

In practical applications, as shown in FIGS. 4 and 5, the specific types of the optical structures of the present disclosure include but not limited to:
single-mode DR4 optical module of 4 core*0.75 mm spacing;
single-mode DR8 optical module of 8 core*0.5 mm spacing;
SR4 optical module of 12 core*0.25 mm spacing (4-reception and 4-transmission optical module); or,
SR8 optical module of 12 core*0.25 mm spacing (8-reception and 8-transmission optical module, using two integrated plastic lenses); or,
non-standard custom design of any core and any spacing, with the reception and transmission core number not limited.

On the above basis, the present disclosure further provides a method of manufacturing an optical structure, which includes the following steps.

At step S1, a light transmission body 1 is prefabricated and a plurality of optical fibers 2 are prepared. A plurality of juxtaposed insertion holes 3 are disposed on the light transmission body 1; a reflection surface 10 is disposed in the light transmission body 1; an avoiding opening 11 is disposed at a front bottom of the light transmission body 1; a plurality of focusing lenses 12 are disposed on a top wall of the avoiding opening 11; and an inclined end surface 20 is disposed at a front end of the optical fibers 2.

At step S2, the plurality of optical fibers 2 are inserted into the insertion holes 3 one to one, where the inclined end surfaces 20 are inclined at a preset angle relative to a vertical surface, and the inclined end surfaces 20 are aligned with the reflection surface 10.

At step S3, the avoiding opening 11 is covered above an optical communication chip 4.

At step S4, when an optical signal is emitted from a front end of the optical fibers 2, the optical signal is reflected by the reflection surface 10 and then transmitted through the focusing lenses 12 to the optical communication chip 4.

In order to fix the optical fibers, in this embodiment, a glue dispensing opening 13 is disposed at a rear end of the light transmission body 1. The manufacturing method further includes a glue dispensing step: filling a fixing glue 14 in the glue dispensing opening 13 such that a plurality of optical fibers 2 are fixed by the fixing glue 14 in the glue dispensing opening 13.

Furthermore, in the step S2, an included angle between the inclined end surfaces 20 and the vertical surface is 6° to 10°. In the step S1, the light transmission body 1 is formed by processing a plastic material, and the focusing lenses 12 are non-spherical focusing lenses.

The module obtained by the above manufacturing method can physically and effectively increase return loss, and the error rate of the optical module is reduced. Further, the optical path can reduce the requirement of the coating reflectance of the reception chip PD surface so as to save the application costs. Furthermore, since the light spot focused by the optical path structure is small, the entire coupling tolerance is large. Further, compared with the original product, the optical path structure is unchanged in external size and is compatible with the original product.

The above descriptions are made to the preferred embodiments of the present disclosure and not intended to limit the present disclosure. All changes, equivalent substitutions, or improvements made within the technical scope of the present disclosure shall fall within the scope of protection of the present disclosure.

1. An optical structure capable of increasing return loss, comprising a light transmission body (1) and a plurality of juxtaposed optical fibers (2), wherein, a plurality of juxtaposed insertion holes (3) are disposed on the light transmission body (1), the plurality of optical fibers (2) are inserted into the insertion holes (3) one to one, an inclined end surface (20) inclined at a preset angle relative to a vertical surface is formed at a front end of the optical fibers (2), a reflection surface (10) aligned with the inclined end surfaces (20) is disposed inside the light transmission body (1), an avoiding opening (11) for accommodating an optical communication chip (4) is disposed at a front bottom of the light transmission body (1), a plurality of focusing lenses (12) in one-to-one correspondence with the optical fibers (2) are disposed on a top wall of the avoiding opening (11), the focusing lenses (12) are located below the reflection surface (10), an optical signal emitted from the front end of the optical fibers (2) is firstly reflected by the reflection surface (10) and then passed through the focusing lenses (12) into the optical communication chip (4).

2. The optical structure of claim 1, wherein an included angle between the inclined end surfaces (20) and the vertical surface is 6° to 10°.

3. The optical structure of claim 1, wherein an included angle between a light beam reflected by the reflection surface (10) and the vertical surface is 6° to 20°.

4. The optical structure of claim 1, wherein the focusing lenses (12) are non-spherical focusing lenses.

5. The optical structure of claim 1, wherein a glue dispensing opening (13) is disposed at a rear end of the light transmission body (1), a plurality of optical fibers (2) run through the glue dispensing opening (13), and a fixing glue (14) is filled in the glue dispensing opening (13).

6. The optical structure of claim 1, wherein the light transmission body (1) is a plastic body.

7. A method of manufacturing the optical structure of claim 1, comprising the following steps:
at step S1, prefabricating a light transmission body (1) and preparing a plurality of optical fibers (2), wherein a plurality of juxtaposed insertion holes (3) are disposed on the light transmission body (1), a reflection surface (10) is disposed in the light transmission body (1), an avoiding opening (11) is disposed at a front bottom of the light transmission body (1), a plurality of focusing lenses (12) are disposed on a top wall of the avoiding opening (11), and an inclined end surface (20) is disposed at a front end of the optical fibers (2);
at step S2, inserting the plurality of optical fibers (2) into the insertion holes (3) one to one, wherein the inclined end surfaces (20) are inclined at a preset angle relative to a vertical surface, and the inclined end surfaces (20) are aligned with the reflection surface (10);
at step S3, covering the avoiding opening (11) above an optical communication chip (4);
at step S4, when an optical signal is emitted from a front end of the optical fibers (2), reflecting the optical signal by the reflection surface (10) and then transmitting the optical signal through the focusing lenses (12) to the optical communication chip (4).

8. The method of claim 7, wherein a glue dispensing opening (13) is disposed at a rear end of the light transmission body (1), and the method further comprises a glue dispensing step:
filling a fixing glue (14) in the glue dispensing opening (13) such that a plurality of optical fibers (2) are fixed by the fixing glue (14) in the glue dispensing opening (13).

9. The method of claim 7, wherein in the step S2, an included angle between the inclined end surfaces (20) and the vertical surface is 6° to 10°.

10. The method of claim 7, wherein in the step S1, the light transmission body (1) is formed by processing a plastic material, and the focusing lenses (12) are non-spherical focusing lenses.

11. The method of claim 7, wherein an included angle between the inclined end surfaces (20) and the vertical surface is 6° to 10°.

12. The method of claim 7, wherein an included angle between a light beam reflected by the reflection surface (10) and the vertical surface is 6° to 20°.

13. The method of claim 7, wherein the focusing lenses (12) are non-spherical focusing lenses.

14. The method of claim 7, wherein a glue dispensing opening (13) is disposed at a rear end of the light transmission body (1), a plurality of optical fibers (2) run through the glue dispensing opening (13), and a fixing glue (14) is filled in the glue dispensing opening (13).

15. The method of claim 7, wherein the light transmission body (1) is a plastic body.
